(19) United States
(12) Patent Application Publication
(10) Pub. No.: US 2020/0323322 A1
(43) Pub. Date: Oct. 15, 2020

(54) Food Transportation System

(71) Applicant: Vanazz Washington, Gilbert, AZ (US)

(72) Inventor: Vanazz Washington, Gilbert, AZ (US)

(21) Appl. No.: 16/382,256

(22) Filed: Apr. 12, 2019

(51) Int. Cl. A45C 11/20; F25D 3/06; A47J 41/00; B65D 81/18; A47J 37/07

(52) U.S. Cl. CPC A45C 11/20; F25D 3/06; F25D 2303/081; B65D 81/18; A47J 37/07; A47J 41/0061

(57) ABSTRACT

A food transportation system for transporting uncooked food items and a grill to an outdoor event includes a cooking unit employed to cook food. The cooking unit has a grill that is removably positioned therein and an uncooked food item is positioned on the grill for cooking. A storage unit is provided that has a chamber and a plurality of drawers. The storage unit has a plurality of wheels to roll along a support surface. Ice, food items and beverages are selectively positioned in the chamber. The grill is removably positioned in a selected one of the drawers to store the uncooked food item on the grill before the food item is cooked. In this way the uncooked food item is carried to an outdoor event.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to transportation devices and more particularly pertains to a new transportation device for transporting uncooked food items and a grill to an outdoor event.

### BRIEF SUMMARY OF THE INVENTION

An embodiment of the disclosure meets the needs presented above by generally comprising a cooking unit employed to cook food. The cooking unit has a grill that is removably positioned therein and an uncooked food item is positioned on the grill for cooking. A storage unit is provided that has a chamber and a plurality of drawers. The storage unit has a plurality of wheels to roll along a support surface. Ice, food items and beverages are selectively positioned in the chamber. The grill is removably positioned in a selected one of the drawers to store the uncooked food item on the grill before the food item is cooked. In this way the uncooked food item is carried to an outdoor event.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a food transportation system according to an embodiment of the disclosure.

FIG. 2 is a top view of storage unit of an embodiment of the disclosure.

FIG. 3 is a left side phantom view of a storage unit of an embodiment of the disclosure.

FIG. 4 is a bottom view of storage unit of an embodiment of the disclosure.

FIG. 5 is a front view of a storage unit of an embodiment of the disclosure.

### DETAILED DESCRIPTION OF THE INVENTION

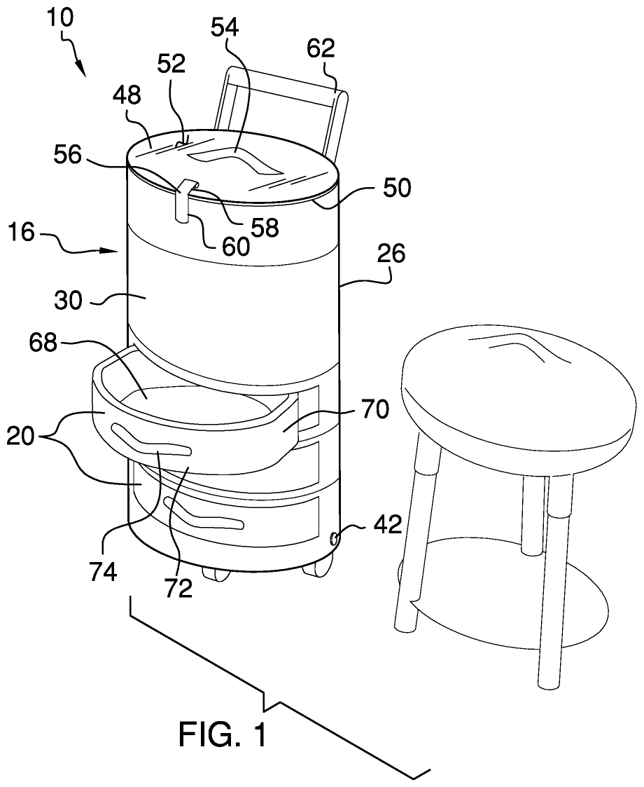

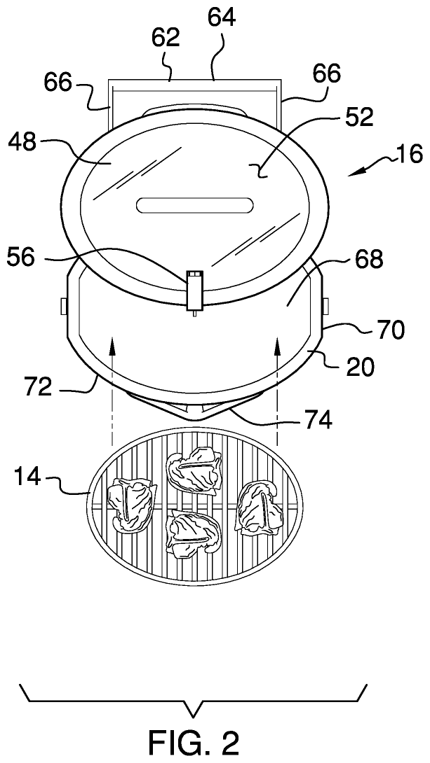

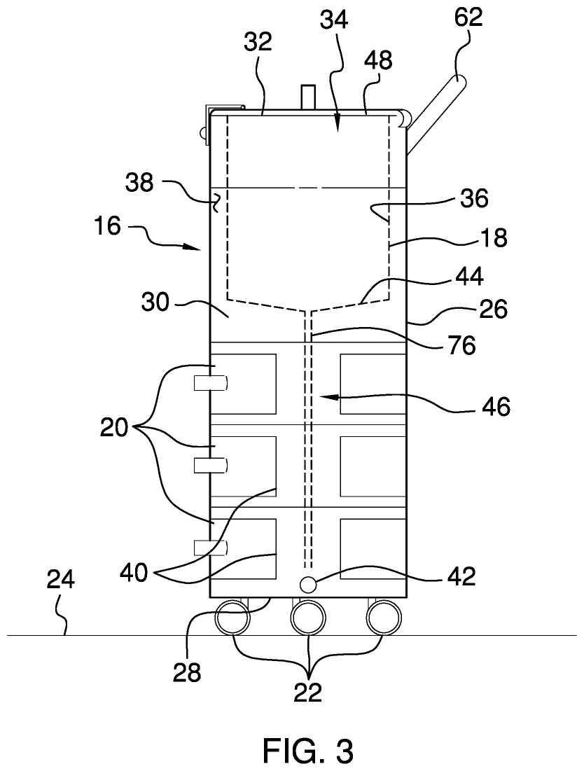

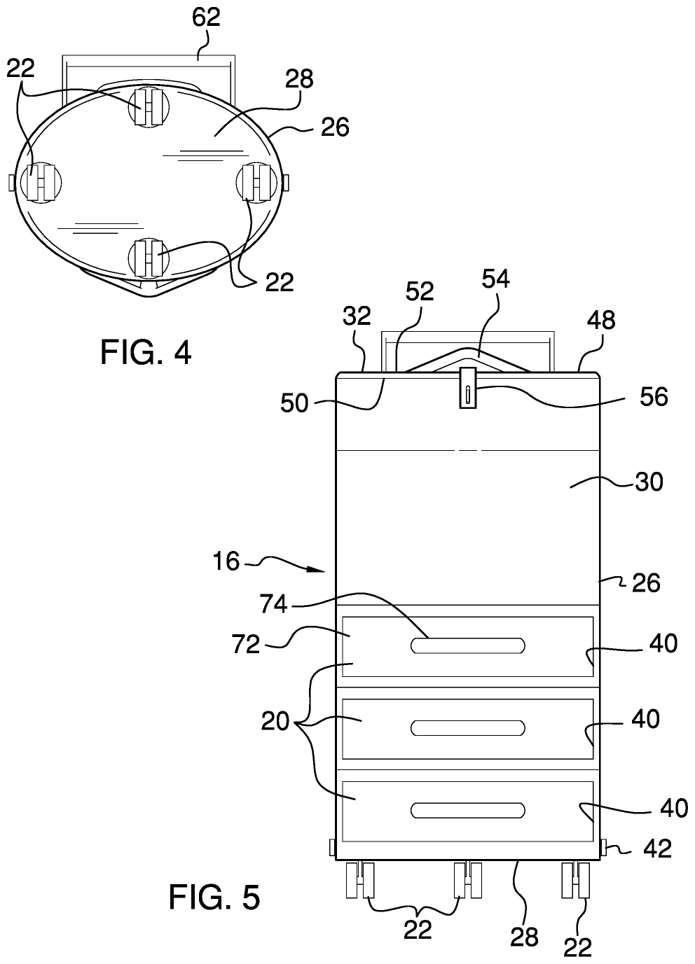

With reference now to the drawings, and in particular to FIGS. 1 through 5 thereof, a new transportation device embodying the principles and concepts of an embodiment of the disclosure and generally designated by the reference numeral 10 will be described.

As best illustrated in FIGS. 1 through 5, the food transportation system 10 generally comprises a cooking unit 12 that is manipulated to cook food. The cooking unit 12 may be a charcoal grill, a gas grill and any other type of outdoor cooking unit 12. Moreover, the cooking unit 12 may be available in a variety of colors. A grill 14 is removably positioned in the cooking unit 12 and a food item is positioned on the grill 14 for cooking. The grill 14 may be a metal grill of any conventional design commonly used in charcoal and gas grills.

A storage unit 16 is provided that has a chamber 18 and a plurality of drawers 20. The storage unit 16 has a plurality of wheels 22 to roll along a support surface 24 such as ground or the like. Ice is selectively positioned in the chamber 18 to cool an interior of the storage unit 16. Moreover, the storage unit 16 is comprised of a thermally insulating material to retain the interior of the storage unit 16 at a selected temperature.

Food items and beverages are selectively positioned in the storage unit 16 for transporting to an outdoor event such as a concert, a sporting event, camping or any other outdoor event. The grill 14 is removably positioned in a selected one of the drawers 20 to store the food item on the grill 14 before the food item is cooked. In this way the uncooked food is carried to the outdoor event and the uncooked food is separated from the contents of the chamber 18. The uncooked food may be raw meat such as beef, chicken and pork, raw vegetables or any other uncooked food.

The storage unit 16 comprises a cylinder 26 that has a bottom wall 28 and an outer wall 30 extending upwardly therefrom. The cylinder 26 is substantially hollow and the outer wall 30 has a distal edge 32 with respect to the bottom wall 28 to define an opening 34 into the cylinder 26. The outer wall 30 has an inside surface 36 and an outside surface 38 and each of the wheels 22 is rotatably coupled to the bottom wall 28. The cylinder 26 may have a height ranging between approximately 1.0 meter and 1.5 meters.

The outer wall 30 has a plurality of openings 40 extending into an interior of the cylinder 26. The openings 40 are spaced apart from each other and are distributed from the bottom wall 28 toward the distal edge 32. The outer wall 30 has a drain 42 extending into the interior of the cylinder 26. A divider 44 is positioned within the cylinder 26 and the divider 44 is coupled to the inside surface 36 of the outer wall 30. The divider 44 is horizontally oriented to define the chamber 18 and a space 46 extending between the bottom wall 28 and the divider 44. Moreover, the divider 44 is positioned between the plurality of openings 40 and the distal edge 32 of the cylinder 26. Each of the openings 40 extends into the space 46 in the cylinder 26.

A lid 48 is provided that has a first surface 50 and a second surface 52. The lid 48 is hingedly coupled to the outer wall 30 of the cylinder 26 and the first surface 50 lies on the distal edge 32 when the lid 48 is in a closed position. The lid 48 is comprised of a translucent material to facilitate the chamber 18 to be visible when the lid 48 is in the closed position. A grip 54 is coupled to the second surface 52 of the lid 48 and the grip 54 is manipulated to open and close the lid 48.

A lock 56 is coupled to the lid 48 and the lock 56 releasably engages the outer wall 30 of the cylinder 26 to retain the lid 48 in the closed position. The lock 56 may have a leg 58 and a foot 60 and the leg 58 may be coupled to the lid 48 having the foot 60 extending downwardly from the lid 48. The foot 60 may engage a clasp on the cylinder 26 or the like. Additionally, the lock 56 may be any conceivable mechanical lock to include, but not be limited to, combination locks, keyed padlocks and other mechanical locks.

A handle 62 is coupled to the outer wall 30 and the handle 62 is manipulated thereby facilitating the cylinder 26 to be rolled along the support surface 24. The handle 62 may include a central member 64 extending between a pair of outward members 66. Each of the outward members 66 may be coupled to the outer wall 30 of the cylinder 26 having the central member 64 being spaced from the distal edge 32 of the cylinder 26. Additionally, each of the outward members 66 may have a telescopically adjustable length to space 46 the central member 64 a selected distance from the distal edge 32.

Each of the drawers 20 has a basal wall 68 and a perimeter wall 70 extending upwardly therefrom. The perimeter wall 70 corresponding to each of the drawers 20 is continuous such that each of the drawers 20 has a circular shape. Thus, each of the drawers 20 may insertably receive the grill 14 having the grill 14 lying on the basal wall 68. In this way the perimeter wall 70 of the corresponding drawer inhibits the grill 14 from falling out of the corresponding drawer when the cylinder 26 is rolled along the support surface 24.

Each of the drawers 20 is slidably positioned in a selected one of the openings 40 such that each of said drawers 20 is positioned in the space 46 in the cylinder 26. The perimeter wall 70 corresponding to each of the drawers 20 has a front side 72. Moreover, the front side 72 of the corresponding drawer is aligned with the outer wall 30 of the cylinder 26 when the corresponding drawer is closed. A handle 74 is coupled to the front side 72 corresponding to each of the drawers 20 and the handle 74 is selectively gripped for opening 34 and closing the corresponding drawer 20.

A conduit 76 is provided and the conduit 76 is positioned within the cylinder 26. The conduit 76 extends between the chamber 18 and the drain 42. In this way the conduit 76 directs water from the melted ice in the chamber 18 outwardly through the drain 42. A plug may be provided and the plug may be removably positioned in the drain 42 to close the drain 42.

In use, the ice is poured into the chamber 18 and the food items and beverages are positioned in the chamber 18 for transporting the food items and beverages to the outdoor event. Additionally, the uncooked food is positioned on one or more of the grills 14 and the one or more grills 14 are positioned in a selected drawer. In this way the uncooked food is kept separate from the food items and the beverages in the chamber 18. The storage unit 16 and the grill 14 are transported to the outdoor event, the uncooked food in each of the drawers 20 is cooked and the food items and beverages in the chamber 18 are consumed.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food transportation system being configured to discretely carry perishable food items with respect to non-perishable food items, said system comprising:
a cooking unit being configured to cook food, said cooking unit having a grill being removably positioned therein wherein said grill is configured to have an uncooked food item positioned thereon for cooking; and
a storage unit having a chamber and a plurality of drawers, said storage unit having a plurality of wheels wherein said storage unit is configured to be rolled along a support surface, said chamber being configured to have ice positioned therein to cool an interior of said storage unit, said storage unit being comprised of a thermally insulating material wherein said interior of said storage unit is retained at a selected temperature, said chamber being configured to contain food items and beverages, said grill being removably positioned in a selected one of said drawers wherein each of said drawers is configured to store the uncooked food item on said grill before the uncooked food item is cooked thereby facilitating the uncooked food item to be carried to an outdoor event.

2. The system according to claim 1, wherein said storage unit comprises a cylinder having a bottom wall and an outer wall extending upwardly therefrom, said cylinder being substantially hollow, said outer wall having a distal edge with respect to said bottom wall to define an opening into said cylinder, said outer wall having an inside surface and an outside surface, each of said wheels being rotatably coupled to said bottom wall.

3. The system according to claim 2, wherein said outer wall has a plurality of openings extending into an interior of said cylinder, said openings being spaced apart from each other and being distributed from said bottom wall toward said distal edge, said outer wall having a drain extending into said interior of said cylinder.

4. The system according to claim 3, further comprising a divider being positioned within said cylinder, said divider being coupled to said inside surface of said outer wall to define said chamber and a space extending between said bottom wall and said divider, said divider being positioned between said plurality of openings and said distal edge.

5. The system according to claim 2, further comprising a lid having a first surface and a second surface, said lid being hingedly coupled to said outer wall of said cylinder having said first surface lying on said distal edge when said lid is in a closed position, said lid being comprised of a translucent material wherein said lid is configured to facilitate said chamber to be visible when said lid is in said closed position.

6. The system according to claim 5, further comprising a grip being coupled to said second surface of said lid wherein said grip is configured to be manipulated.

7. The system according to claim 5, further comprising a lock being coupled to said lid, said lock releasably engaging said outer wall of said cylinder to retain said lid in said closed position.

8. The system according to claim 2, further comprising a handle being coupled to said outer wall wherein said handle is configured to be manipulated thereby facilitating said cylinder to be rolled along the support surface.

9. The system according to claim 3, wherein each of said drawers has a basal wall and a perimeter wall extending upwardly therefrom, said perimeter wall corresponding to each of said drawers being continuous such that each of said drawers has a circular shape thereby facilitating said grill to be placed in a selected one of said drawers, each of said drawers being slidably positioned in a selected one of said openings.

10. The system according to claim 3, further comprising a conduit being positioned within said cylinder, said conduit extending between said chamber and said drain wherein said conduit is configured to direct water from the melted ice outwardly through said drain.

11. A food transportation system being configured to discretely carry perishable food items with respect to non-perishable food items, said system comprising:
a cooking unit being configured to cook food, said cooking unit having a grill being removably positioned therein wherein said grill is configured to have an uncooked food item positioned thereon for cooking; and
a storage unit having a chamber and a plurality of drawers, said storage unit having a plurality of wheels wherein said storage unit is configured to be rolled along a support surface, said chamber being configured to have ice positioned therein to cool an interior of said storage unit, said storage unit being comprised of a thermally insulating material wherein said interior of said storage unit is retained at a selected temperature, said chamber being configured to contain food items and beverages, said grill being removably positioned in a selected one of said drawers wherein each of said drawers is configured to store the uncooked food item on said grill before the uncooked food item is cooked thereby facilitating the uncooked food item to be carried to an outdoor event, said storage unit comprising:
a cylinder having a bottom wall and an outer wall extending upwardly therefrom, said cylinder being substantially hollow, said outer wall having a distal edge with respect to said bottom wall to define an opening into said cylinder, said outer wall having an inside surface and an outside surface, each of said wheels being rotatably coupled to said bottom wall, said outer wall having a plurality of openings extending into an interior of said cylinder, said openings being spaced apart from each other and being distributed from said bottom wall toward said distal edge, said outer wall having a drain extending into said interior of said cylinder,
a divider being positioned within said cylinder, said divider being coupled to said inside surface of said outer wall to define said chamber and a space extending between said bottom wall and said divider, said divider being positioned between said plurality of openings and said distal edge,
a lid having a first surface and a second surface, said lid being hingedly coupled to said outer wall of said cylinder having said first surface lying on said distal edge when said lid is in a closed position, said lid being comprised of a translucent material wherein said lid is configured to facilitate said chamber to be visible when said lid is in said closed position,
a grip being coupled to said second surface of said lid wherein said grip is configured to be manipulated,
a lock being coupled to said lid, said lock releasably engaging said outer wall of said cylinder to retain said lid in said closed position,
a handle being coupled to said outer wall wherein said handle is configured to be manipulated thereby facilitating said cylinder to be rolled along the support surface,
each of said drawers having a basal wall and a perimeter wall extending upwardly therefrom, said perimeter wall corresponding to each of said drawers being continuous such that each of said drawers has a circular shape thereby facilitating said grill to be placed in a selected one of said drawers, each of said drawers being slidably positioned in a selected one of said openings, and
a conduit being positioned within said cylinder, said conduit extending between said chamber and said drain wherein said conduit is configured to direct water from the melted ice outwardly through said drain.
